(19) United States
(12) Patent Application Publication
(10) Pub. No.: US 2007/0269023 A1
(43) Pub. Date: Nov. 22, 2007

(54) Crisis communication system and method utilizing group-based message distribution

(76) Inventors: Tamra Keenan Klauer, El Dorado Hills, CA (US); Mary Kay Clark, Oregon, WI (US)

Correspondence Address: BACON & THOMAS, PLLC, 625 SLATERS LANE, FOURTH FLOOR, ALEXANDRIA, VA, 22314, US

(21) Appl. No.: 11/434,880

(22) Filed: May 17, 2006

(51) Int. Cl. H04M 11/04

(52) U.S. Cl. 379/37

(57) ABSTRACT

A system and method of crisis communication includes a plurality of crisis communication points (CCPs) located in geographic dispersed areas unlikely to all be affected by a single disaster, and which are arranged to store messages left by individuals affected by a crisis for retrieval at any time by interested parties who call the CCP. Each individual associated with a subscriber, including family members, friends, and associates, has an individual box accessible through a telephone number coupled with a personal identifier and an optional individual or group password, and may (a) record a message, the message being distributed to all individual boxes in a group, and/or (b) play back messages from other box holders. Any messages recorded in one of the call boxes may be automatically distributed to all other voice mail boxes in the group of personal boxes associated with a contact list or, optionally, limited to selected personal boxes. Notification of next-of-kin may be facilitated by providing subscribers with a card instructing officials/medical personnel to contact a CCP and leave a message for automatic distribution to next-of-kin personal boxes.

### BACKGROUND OF THE INVENTION

1. Field of the Invention

This invention relates to a system and method that enables parties affected by a regionalized catastrophe such as a natural disaster or terrorist attack, or by any other emergency affecting telephone access, to communicate with concerned inquirers.

In particular, the invention relates to a system and method by which subscribers may leave messages for friends and relatives in case of an emergency. The system utilizes voice mail boxes as a repository for messages, but adds a group-based automatic message distribution protocol by which messages left in a voice mail box associated with a subscriber are distributed to each of a list of predetermined, associated boxes, and optionally to other boxes designated by the subscriber, so that individuals with access to one of the boxes in a group of associated mailboxes hears, and may replay and respond to, messages left by any of the associated subscribers.

By placing a single telephone call, any subscriber associated with the group can check the status of others in the group and at the same time communicate his or her own status to interested parties. This helps to relieve the immediate burden on overloaded communications systems during a regionalized crisis, enabling survivors to concentrate on tasks other than trying to contact others. In addition, it facilitates communications among the group of interested parties in situations where telephone access is restricted, such as a hospital waiting room.

Furthermore, the invention streamlines and simplifies the process by which voice mail messages are recorded and distributed, facilitating use of the system during a crisis.

In addition, the invention includes features that are useful in contexts or applications other than crisis communications. For example, the invention provides a voice mail system in which multiple entry points, for example a home phone number and also a cell phone number, are associated with individual voice mail boxes. Conversely, the invention also provides a voice mail system in which a common phone number (or at least one common phone number) is associated with multiple voice mail boxes, access being obtained by a unique two-step process involving both the common telephone number and a personal identifier.

2. Description of Related Art

Despite advances in telecommunications technology, including the widespread distribution of mobile phones and high speed communications networks, telecommunications systems continue to be disrupted by crises, ranging from terrorist attacks to hurricanes and earthquakes. As was evident during the Loma Prieta earthquake of October, 1989, the terrorist attacks on New York City and Arlington, Va. in September, 2001, and Hurricane Katrina in August, 2005, the telecommunications infrastructure of even a technologically advanced country such as the U.S.A. can be overwhelmed by a natural or manmade disaster, making it difficult for survivors to inform relatives, friends, and business associates of their status. In less technologically developed areas, such as the Indian Ocean coastal areas affected by the December, 2004, tsunami, it can take weeks or even months before communications are restored.

Furthermore, in the event of a regional crisis, individuals who are unable to communicate due to injuries or death are admitted to hospitals, and officials are expected to make efforts to contact the individual's next-of-kin within 24 hours of admission. The large number of injuries resulting from such a crisis makes the notification process difficult, and when combined with the overburdened communications facilities that occur during a crisis, and the fact that next-of-kin may be displaced by the disaster, prompt notification for many individuals could be virtually impossible.

Even when telecommunications systems are fully operational in the absence of a regional crisis, it may be difficult for individuals to inform interested parties of their status in the event of a personal emergency. For example, the individual and friends or family may be in an emergency room or hospital where cell phone use is prohibited, or they simply may not have the time or ability to inform all interested parties of the situation.

To address these problems, the present invention provides for the use of a crisis communication point (similar to a voice mail system) situated at a central location, or networked between multiple geographically dispersed locations, where voice messages are left in the event of a crisis. The use of voice mail boxes in general to leave messages is, of course, known. However, unlike conventional voice mail systems, in which messages are normally recorded and addressed on an individual basis, the system of the invention is specially adapted, using a group message distribution protocol and an inter-related system of “boxes,” to provide shared message access for a number of predetermined individuals. Distribution of messages to all related subscriber boxes is automated so that a single message is recorded for all related users to hear. The system also provides for the optional recording of a private message to one or more related subscribers.

The system is designed for ease-of-use, automating and simplifying the steps required to access the system, identify the subscriber and all of his or her related subscribers, play and store all related new messages, and also record and distributed a message from one subscriber to all related subscribers, so that even children can use the system. Each individual mailbox is identified in a relational database, and accessed by one of multiple identifiers such as the user's home telephone number or cell phone number, followed by an additional identifier (such as the user's birthday). The design permits each member of the related group to play, replay, and respond to messages left by any member of the group upon access to the member's “personal box.”

It is possible that voice mail systems such as the ones disclosed in U.S. Pat. Nos. 4,585,906 and 4,602,129 (both to Matthews), which utilize group identifiers and passwords to enable broadcasting of messages to multiple boxes connected to different private branch exchanges (PBXs), might have some utility during an emergency. However, the complexity of these systems is designed to provide a robust set of features for business users (and other trained users). Such systems require each subscriber to follow a lengthy string of prompts in order to establish a list of related mailboxes, and then to follow another set of prompts to record and send messages to the list. Additionally, in order for every message from any user in a related group to be distributed to every related subscriber, each subscriber in the group would need to follow the setup prompts individually in order to create a distribution group within his or her mailbox. Due to the robust features of these systems, user training is typically performed to instruct subscribers on the use of even the most basic features of such systems. Neither of these systems provides a simplified process through which messages can easily be played, responded-to, and easily and automatically distributed to all related subscribers. As a result, neither system provides the level of simplified message distribution that would be practical during a regionalized crisis.

On the other hand, prior systems that are specifically intended to facilitate communications during emergencies have focused on call-out capabilities, i.e., on making calls to interested parties in order to notify them that an emergency has occurred. Most of these systems play standard messages, although the system disclosed in U.S. Pat. No. 5,295,126 (Carrier) does provide for emergency notification via voice mail accessible by designated parties via a central telephone number. In the Carrier system, a message is recorded in a voice mail box accessible through a common telephone number for distribution to designated parties, and interested parties are automatically called to inform that a message has been recorded.

An emergency notification system such as the one disclosed in the Carrier patent, which automatically dials the designated parties rather than waiting for them to call in, presents a number of problems. For example, the automatically called parties may not be in a position to receive telephone calls except for limited times, and therefore may miss the messages. Second, an automatic calling system ties up phone lines by placing a large number of calls in a short period of time, placing additional call traffic on communications facilities which are typically already overburdened within a disaster zone. Third, callers cannot leave their own messages, and there is no way to distribute messages to the boxes of other interested parties. As a result, emergency notification systems of the type disclosed in the Carrier patent are not useful during regionalized crises, and have limited applicability in general.

In addition to the voice mail and emergency notification systems discussed above, the following patents offer background for the present invention: U.S. Pat. No. 6,295,346 (Markowitz), which discloses an automatic 911 notification system in which the system that automatically calls and plays a message for a set of parties whenever a 911 call is placed; U.S. Pat. No. 5,903,726 (Donovan), which discloses a voice mail alert system for use in connection with wireless SMS services (see FIG. 4); and U.S. Pat. No. 5,854,827 (Maurer), which discloses distribution of messages to individual voice mail boxes and notification of subscribers.

None of the systems disclosed in these patents even remotely offers a solution to the type of catastrophic communications breakdowns that can occur during a large-scale regional crisis, such as the flooding that recently occurred on the Gulf Coast following Hurricane Katrina, and none offers more than a partial solution to the problem of notifying family members, friends, and associates of status during other types of emergencies.

### SUMMARY OF THE INVENTION

It is accordingly a first objective of the invention to provide a system and method of enabling individuals to notify interested parties of status during a crisis, without tying up large numbers of phone lines, by making a single call and leaving a message that can be retrieved by others at their convenience or whenever outside lines become available.

It is a second objective of the invention to provide a system and method of enabling individuals to notify interested parties of status during a crisis, and in addition to respond to status inquiries, by making a single call.

It is a third objective of the invention to provide a system and method of enabling individuals to notify interested parties of status during a crisis, that is accessible through a single central number that can be reached at a caller's convenience in order to enable the caller to determine the status of family members, friends, and associates, and to leave individualized messages, and which associates multiple boxes with a single subscriber account in order to simplify management and operation of the system.

It is a fourth objective of the invention to provide a crisis communication system which provides easily remembered mailbox numbers for each user, allowing a single mailbox number (such as a home telephone number, for example) to accommodate multiple users, and additionally allowing multiple numbers (such as a home telephone number and also a cell phone number) to target a single mailbox on the system.

It is a fifth objective of the invention to provide a crisis communication system that is simple enough to use that even children and elderly persons with diminished capacity can use the system.

It is a sixth objective of the invention to provide a crisis communication system that is simple and inexpensive to operate and use, and that therefore can be duplicated at geographically dispersed Crisis Communication Points (CCPs) in order to provide sufficient redundancy to ensure operation even if one CCP is destroyed or disabled.

It is a seventh objective of the invention to provide a resource for the notification of Next-of-Kin of an incapacitated subscriber.

It is an eighth objective of the invention to provide a voice mail system in which multiple entry points are provided for individual boxes, and in which related boxes may be accessed by a common phone number identified with the boxes and augmented by a personal identifier.

These objectives are accomplished, in accordance with a preferred embodiment of the invention, by providing a system and method that includes a plurality of CCPs located in geographically dispersed areas unlikely to all be affected by a single disaster, and which are arranged to store messages left by individuals affected by a crisis for retrieval at any time by interested parties who call the CCP.

A key feature of the invention is that each individual associated with a subscriber, including family members, friends, and associates, has an individual box accessible through group and individual identifiers, and that enables the individual to (a) play back messages from the associated box holders at any time, and (b) record a message at any time, the message being distributed to all individual voice mail boxes in a group, thereby enabling the individual to not only determine the status of other individuals in the group, but also to respond to inquiries without making additional telephone calls. The response feature is made possible because any message recorded in one of the voice mail boxes is distributed to all other boxes in the group. The distribution is preferably automatic, although it is possible that a caller could be given the option of limiting distribution of a private message to one (or more) selected boxes.

According to the method of the invention, incoming calls are initially routed to a system box, where the calling party is identified by the caller's telephone number and a personal identifier (such as one's birthday, for example). Once identified, the call is routed to an individual or “personal” box to which the caller has previously been assigned. Upon accessing the box, (depending upon the design of the individual's personal box) the caller may either initially hear messages left in the box, or record a message. Any messages left in the box are automatically distributed to other boxes based on a contact list, or optionally, privately recorded for one or more specific individuals.

Optionally, the system and method of the invention may include a next-of-kin notification feature, by which emergency or medical personnel may notify the next-of-kin of a subscriber who has died or been rendered incapable of communicating. According to the next-of-in notification features, subscribers are provided with a card instructing officials/medical personnel to contact a CCP and leave a message for automatic distribution to next-of-kin personal boxes.

The system and method of the invention is suitable for use in connection with a variety of crises, including not only major natural disasters, terrorist related disasters, and wartime disasters, but also family emergencies such as hospitalization of a family member. In the latter case, the system enables persons in a hospital waiting room to notify others and/or receive return messages without the need to tie up payphones or to leave the hospital in order to turn on cellular telephones while waiting for return calls.

In addition, the invention provides for messages to be stored at CCPs located in widely spaced geographic locations, to ensure that a CCP will be available for any geographically localized crisis, and to ensure that communication lines to the CCP are not affected by the crisis.

Finally, those skilled in the art will appreciate that the system and method of the invention can readily be implemented by adapting existing voice mail and routing technology, and that the invention is not limited to crisis communications, but may be used in connection with other voice mail systems or call centers in general.

### BRIEF DESCRIPTION OF THE DRAWINGS

FIG. 1 is a block diagram illustrating the arrangement of a Crisis Communication Point (CCP) constructed in accordance with the principles of a preferred embodiment of the invention.

FIG. 2 is a block diagram illustrating the functions of the various “boxes” illustrated in FIG. 1.

FIG. 3 is a flow diagram of a method of using the system of FIG. 1.

FIG. 4 is a sample of the database, reflecting how various subscriber information may overlap.

FIG. 5 is a diagram showing how multiple family groups may overlap and interact with each other.

FIG. 6 is an abbreviated flow diagram of an operational example of the method illustrated in FIG. 3.

FIGS. 7-15 are an expanded flow diagram of the operational example provided in FIG. 6.

FIG. 16 shows a contact list time stamp summary.

### DETAILED DESCRIPTION OF THE PREFERRED EMBODIMENTS

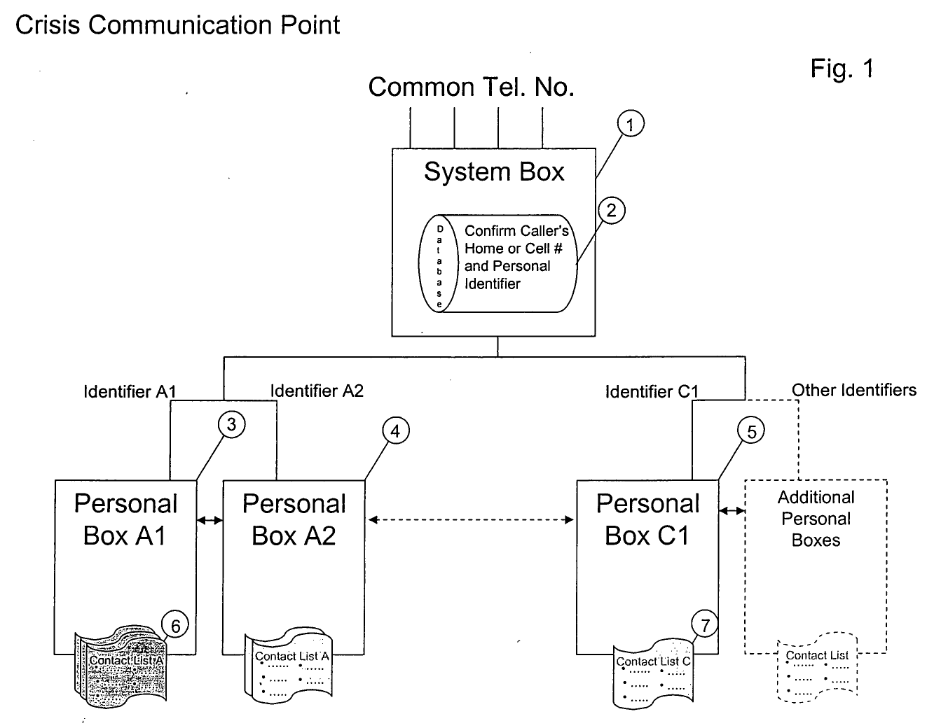

FIG. 1 is a block diagram of a Crisis Communication Point (CCP) arranged according to the principles of a preferred embodiment of the invention. The CCP is preferably one of a plurality of geographically dispersed but essentially identical CCPs having the same capabilities so as to provide a measure of redundancy in case one of the CCPs is disabled during a crisis.

The CCP is accessible over a plurality of incoming lines that share a single common telephone number and are connected to a system box 1. System box 1 is arranged to answer each call upon receipt, determine the call's Caller ID, and to enable dial tone multi-frequency (DTMF), digital, or voice input in response to recorded prompts that are played back when a connection is established.

The common telephone number is preferably an easily remembered number that can be publicized by advertisement prior to a crisis. For example, the number might spell-out a phrase such as 1-800-IAM-OKAY (1-800-426-6529 on a conventional telephone keypad). A large number of telephone lines is preferably provided so that as many callers of the common number as possible will reach and be answered by the system box 1. In addition, automatic routing by Caller ID may be utilized by the telephone service provider that maintains the incoming lines, to route calls to a CCP with redundant messaging capabilities which is geographically most likely to be operational in a crisis. Also, automatic switching from one CCP to another may be provided by the telephone service provider in case all of the ports of the primary system are busy, or in case the primary target system is affected by a crisis. Automatic Call Distribution (ACD) features may also be provided either by the telephone service provider, or within the system in order to hold a number of calls in queue for any of the networked CCPs in the event all ports are busy, so that they may be answered as soon as ports on one of the systems become available. ACD is a well-known technology. The ACD features utilized may include by way of example, and not limitation, automatic queuing of calls, changeable recorded delay announcements, interflow and intraflow capabilities, real-time route preference reconfiguration, and agent/port activation and deactivation.

Each CCP includes a similar hardware configuration and exact software mirror duplicating the design of the primary system. This arrangement of networked system hardware and software with real-time (or slightly delayed) data transfer between systems is similar to a conventional message center or voice mail system (albeit with additional functions, as described below) and may be implemented by the same currently-available hardware.

As with the conventional voice mail system, calls may be routed to or associated with a personal mail box 2,3 based on input by the user of the subscriber's telephone number and password. However, in addition, calls may be routed to the personal box based on one of multiple telephone numbers (home or cell) associated with the box, augmented by a personal identifier. The caller identification may be automatic, for example via automatic caller identification, but it is preferable to at least provide for caller input in case the subscriber is calling from a number which is not available in the database. Caller input of the personal identifier would be provided as well.

To enable caller input, the system box 1 preferably speaks the telephone number reflected by the Caller ID and asks the caller if that is his or her primary home or cell phone number. If it is not, system box 1 prompts the caller to input a home or cell telephone number (or other identifier). System box 1, receives and processes the input using standard voice or dial tone multi-frequency (DTMF) processing, looks up the identifier in a database, and associates the identifier with one of several personal boxes 3.

Once the system box 1 has verified the caller phone number in its database 2 in order to associate the caller with one of several personal boxes, the system box prompts the caller for a further identifier and, optionally, a password, and routes the call to the caller's specific personal box 3.

Each personal box 3 is associated with other related personal boxes on the system based on an associated contact list containing other related personal box numbers. The number of personal boxes 4,5 associated with the contact list 6 is arbitrary, and may for example depend on a service level paid-for by the primary subscriber to the contact list.

In combination with the subscriber's home or cellular phone number, each of the personal boxes has a unique personal identifier, which may by way of example and not limitation be the birthday of a person associated with the box. The simpler the identifier, the easier it is for the system to be used by a child or person of limited capacity. In addition, the caller may be prompted for a password, which may be common to all personal boxes associated with the contact list, and may be in the form of information known to all members of the family or group. Alternatively, it is within the scope of the invention to provide for different passwords, and to associate different levels of access with the different passwords. For example, a password provided to business associates may provide only for playback of messages from, or distribution of messages to, the subscriber and not personal boxes assigned to the subscriber's children. Similarly, a password issued for Next-of-Kin notification may cause the system to offer the notifying caller a separate set of prompts and may restrict the ensuing message delivery of such sensitive information to one (or more) predetermined personal mailboxes, rather than the entire contact list.

Input of the personal box identifier and the password may be taken care of by the system box 1, or the call may be routed to separate hardware (or software routing table) associated with the appropriate contact list 6 before input of the password. In either case, the identifier and password are preferably input by the caller in a manner similar to the caller identifier, for example, using voice or DTMF tones, and matched with entries in a database. Upon entry and verification of all required information, the call is routed to a corresponding personal box, and the caller is presented, in a predetermined order, with playback of messages already recorded or the ability to first record a message (before hearing others' recorded messages).

A key feature of the invention is that messages recorded in any one of the personal boxes on a contact list are distributed to all of the call boxes in the group (unless specifically restricted). For example, if the caller whose personal box is box 3 calls in and leaves a message, the message will be accessible to the persons associated with box 4. Caller 3 might leave the message, “I've been evacuated to Baton Rouge and am staying at the Sleepytime Motel.” When the caller assigned to personal box 4 calls in and is granted access, he or she will hear the message from caller 3. He or she can then record his or her own message for distribution to all of the other boxes on the contact list. Optionally, the caller may also have the option of limiting distribution of the message, although automatic distribution to all boxes is preferred because it simplifies operation and use of the system.

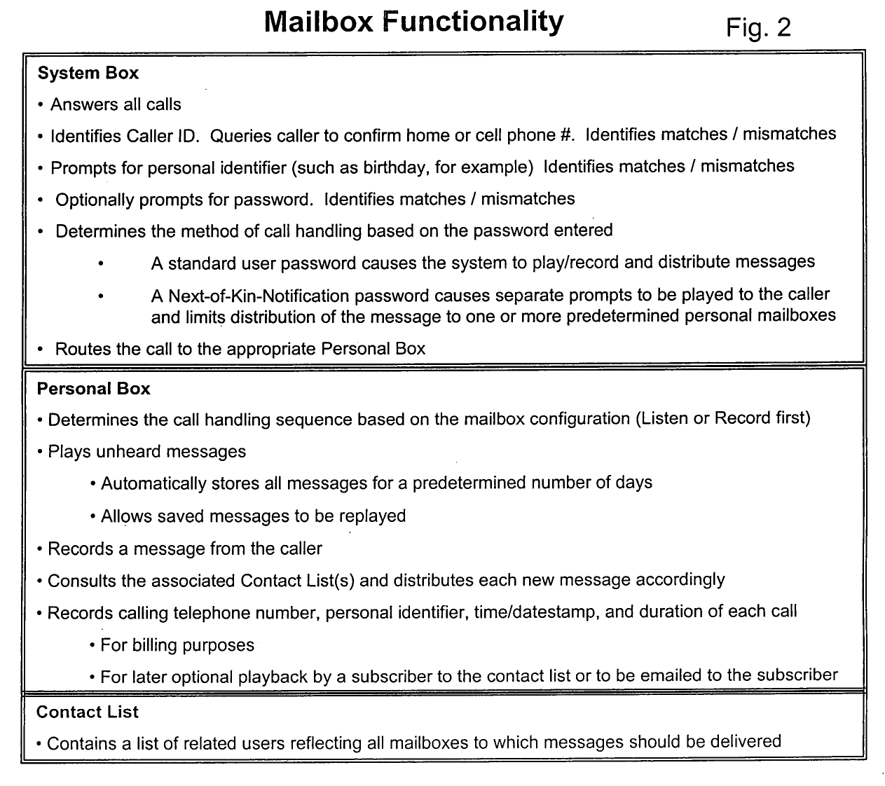

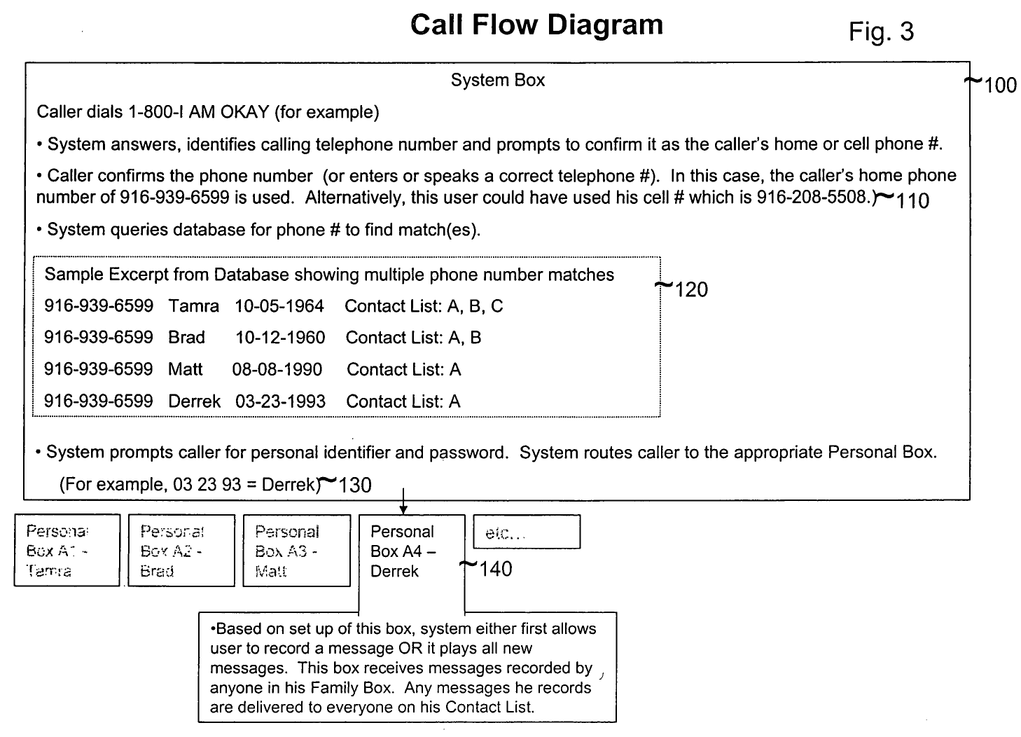

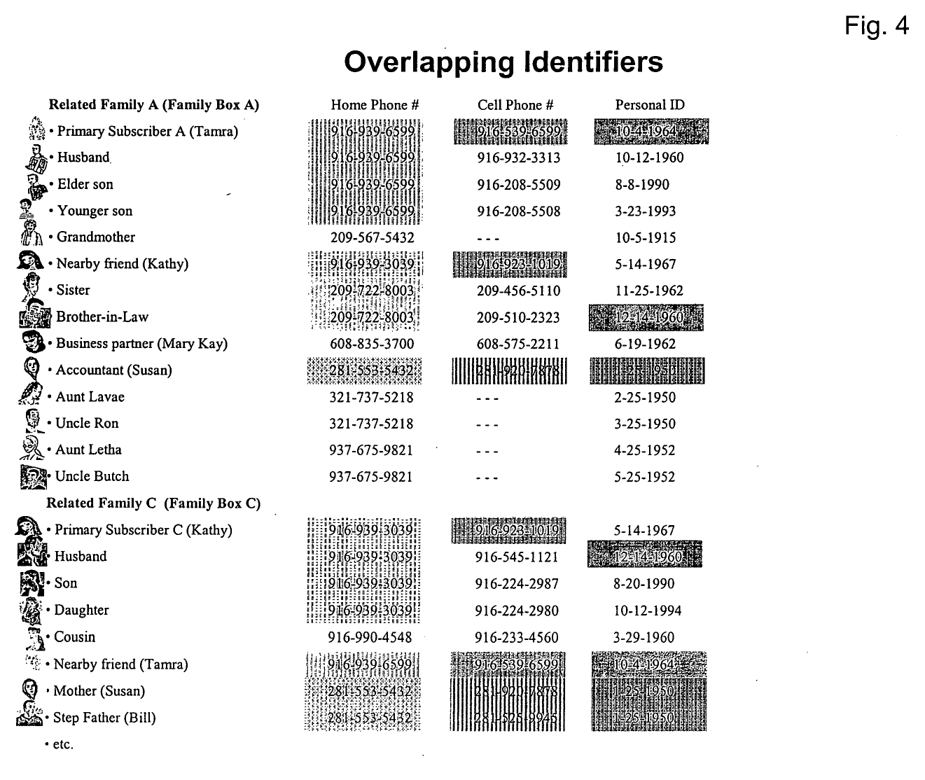

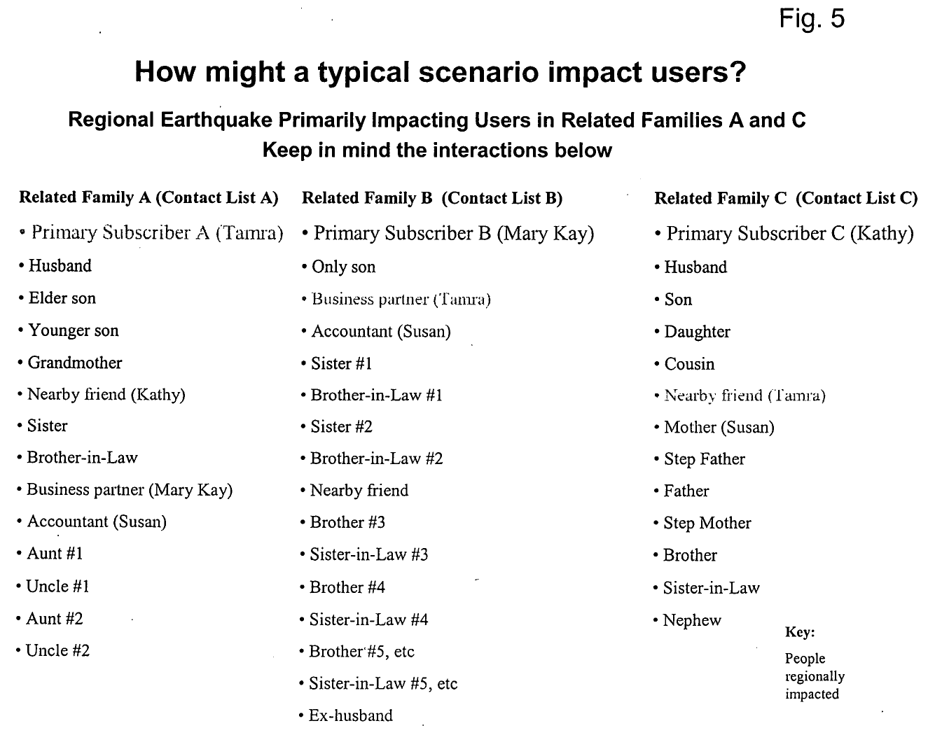

FIG. 3 is a flow diagram illustrating operation of the system of FIGS. 1 and 2. Initially, as indicated by block 100, the caller dials a central number. The system answers and asks if the telephone number identified by Caller ID is the caller's primary home or cell phone #. If not, the system prompts for a phone number. The phone number may be entered through the telephone keypad using DTMF tones or spoken. Both DTMF tone recognition and voice recognition are well-known technologies. The system box then checks a database to determine all associated personal boxes. Multiple phone numbers (home or cell) may be associated with each subscriber, as indicated by block 110. Additionally, each phone number may be associated with multiple personal boxes, as indicated by block 120.

If the phone number is not in the database, the system box plays a message to inform the caller that the phone number is not known, and optionally to invite the caller to try another number or call a separate toll-free telephone number to sign up for a box. If the phone number is in the database, then the caller is prompted for the personal identifier, and the system checks whether the input identifier corresponds to a personal box associated with the caller's telephone number (step 130). If the identifier is recognized, the caller is routed to the personal box (step 140). If not, a message is optionally played informing the caller that the identifier is incorrect and, optionally, inviting the caller to try again and/or providing information so that caller may contact customer service for a new subscription.

As illustrated in FIG. 3, the system then checks in step 130 for an optional password associated with the personal box. If the password is verified, (or if no password is required on the box) the system determines if the design of this particular box is to first record a message which will be distributed to others, or to first hear any messages from related users that have been recorded. (Users with diminished capacity may benefit from recording a message first.) The sequence may differ from box to box. If the box is designed to record first, the caller is prompted to record a message, and the message is automatically distributed to all personal boxes on the associated contact list(s). If the box is designed to hear new messages first, the system will playback all new messages. More advanced options may also be provided to delete messages, record a new message after playback, playback messages after recording, playback all or selected old messages, and so forth. Such options, however, may complicate system operation for many users, and are not required for basic system use.

According to the invention, each personal box preferably provides the capability of playing back all messages recorded upon access to any of the personal boxes on a contact list. In addition, the subscriber may authorize messages recorded in any of the personal boxes of a contact list to also be playable in personal boxes associated with other subscribers and/or contact lists. For example, in the system of FIG. 1, one or more persons accessing personal box “A1” (box 3) would have access to messages left in personal box “C1” (box 4), provided the subscriber is associated with both contact lists. In the illustrated example, subscriber A1 (box 3) has access to all messages left for any member of contact list A and contact list C.

In addition to automatic distribution of messages to all related subscribers on a contact list, it is optionally possible for the system to allow a private message to be recorded for one or a small number of related boxes. For example, by pressing a predetermined key (such as the * key) the system would play each of the names of the subscribers on the user's contact list. Upon hearing the name of one or more parties to whom the user opted to send a private message, the user would press the predetermined key again. Prior to the recording of the message, the system would play back the names of any users to whom the private message would be sent, and allow the user to add or delete names from the private message list.

In addition or alternatively to the optional private message feature, a next-of-kin notification feature may be provided, by which an official may leave notification for next-of-kin in the even of a death, accident, or other condition rendering a subscriber incapacitated or unable to communicate. Next-of-Kin Notification legislation has been recently enacted in California and Illinois, and it is increasingly coming to public attention that national legislation is needed to ensure that Next of Kin is contacted within 24 hours of hospital admission of a person who is unable to communicate or make medical decisions for any reason. For example, a user is in a car accident (whether or not relating to a regional catastrophe), and is admitted to the hospital unconscious. A nurse or other hospital employee follows procedures to contact the Next of Kin, but may be unable to reach anyone. Upon finding a next-of-kin (NOK) card, the nurse could call a CCP with the subscriber info and follow the instructions on the card to leave a NOK message stating that the person is at XYZ Hospital. Depending on the wishes of the NOK subscriber, the NOK notification would automatically be distributed to one or more predetermined specific personal boxes on the system. When family members become worried, they could check in with the CCS, and they would hear the notification. The nurse could also check in periodically by following slightly different instructions to determine whether or not the NOK notification message had been heard by a family member. A time and datestamp would be recorded to indicate that the message was retrieved.

In an exemplary implementation of this feature, the NOK card is arranged to be carried by a user in his or her wallet. The card contains the card carrier's name, the telephone number for accessing the system, one or both of the related telephone numbers for the card carrier, the card carrier's personal identifier, and a separate NOK notification password. When the system box recognizes the NOK notification phone number/personal identifier/password string, the system provides a separate set of prompts to the caller, indicating that his or her private next-of-kin-notification message left will be distributed to one or more specific individual mailboxes. The system also instructs the notifier that, if interested, he or she may call back into the system using the card carrier's telephone number, personal identifier, and next-of-kin-notification password followed by the * key to hear confirmation of whether or not the next-of-kin message(s) left have been retrieved, along with a time and datestamp of retrieval.

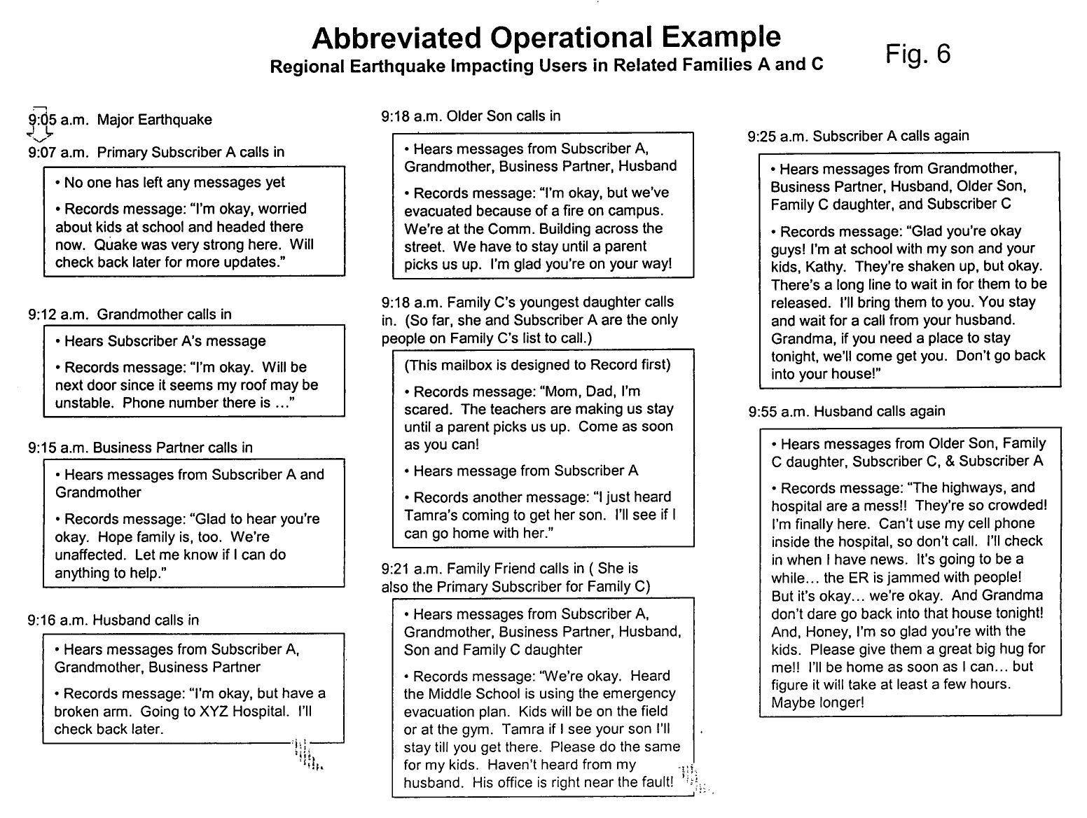

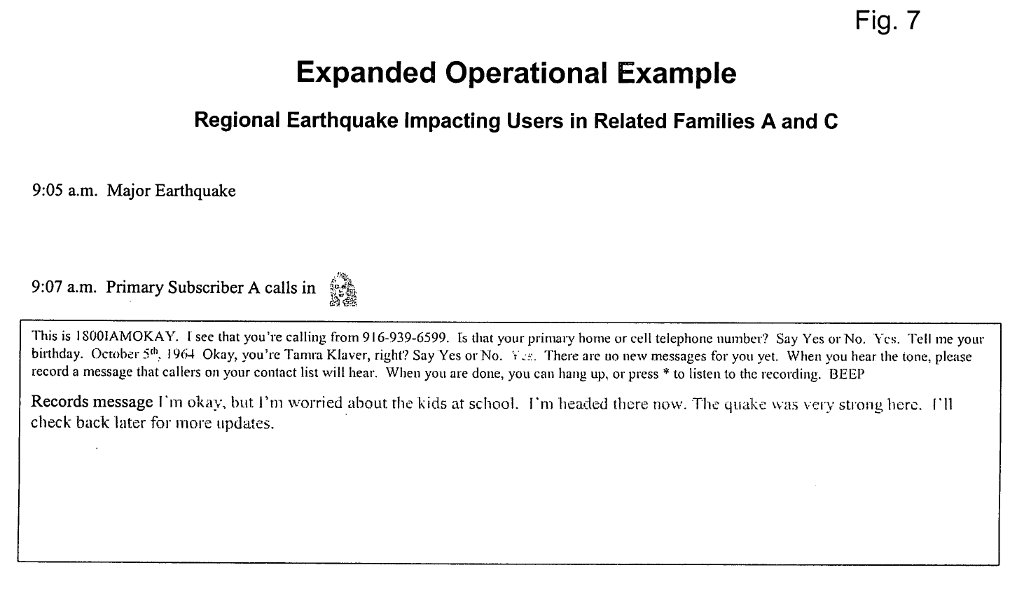

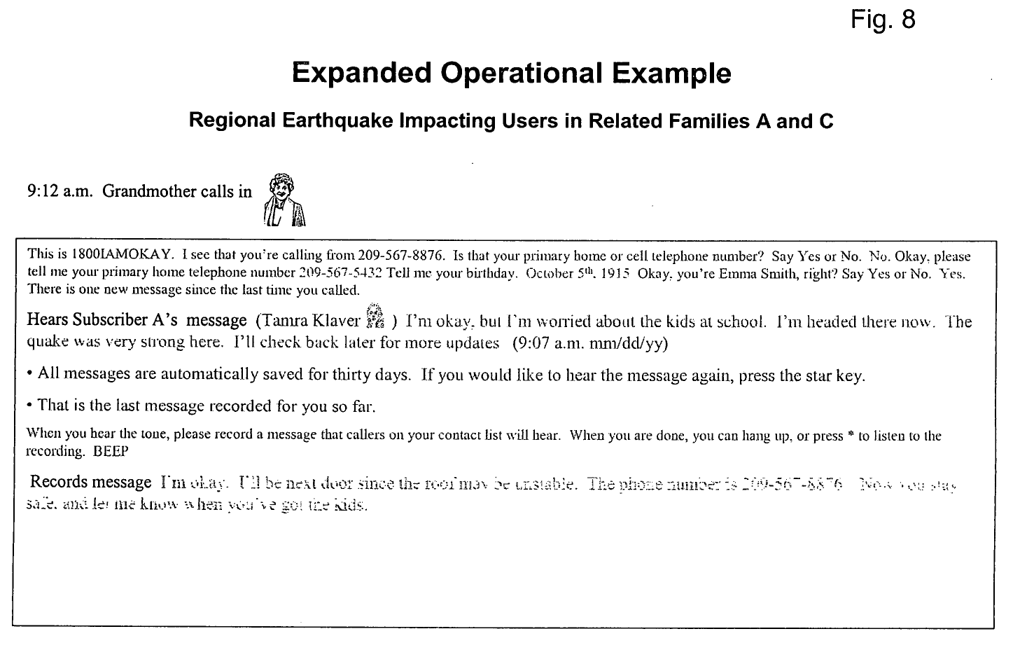

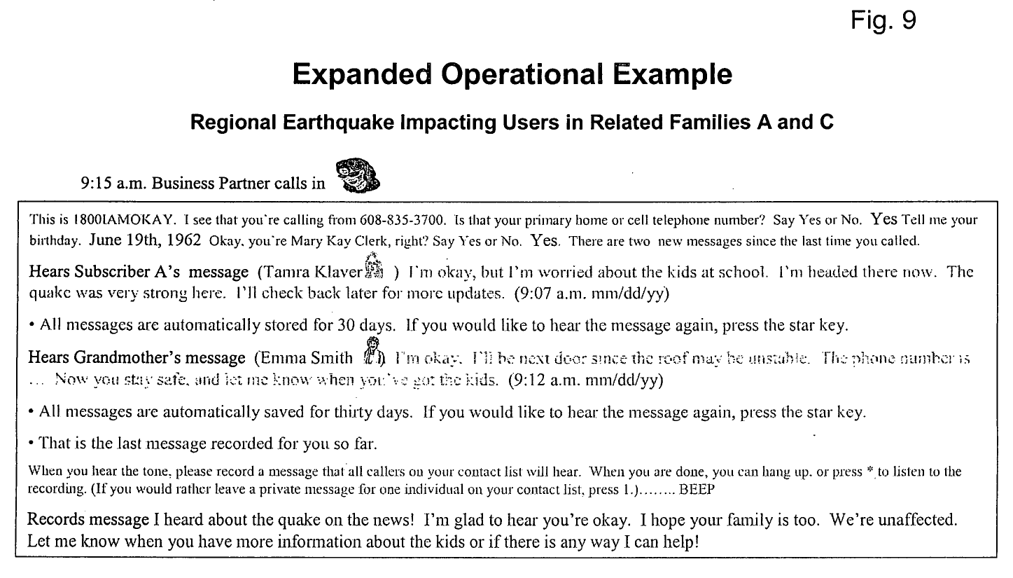

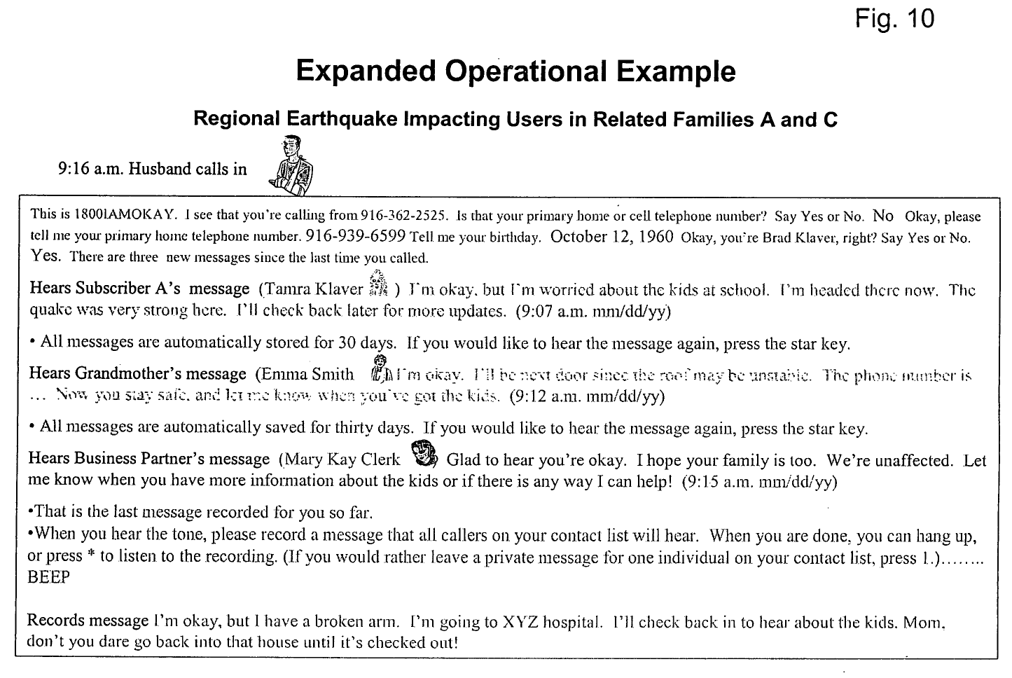

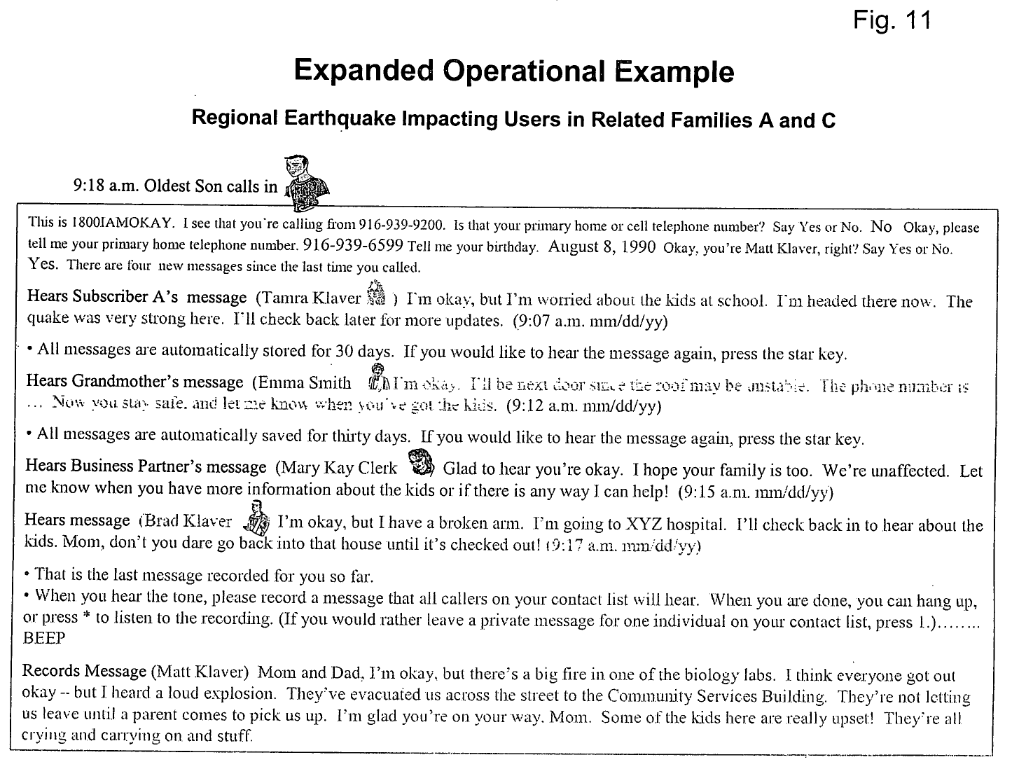

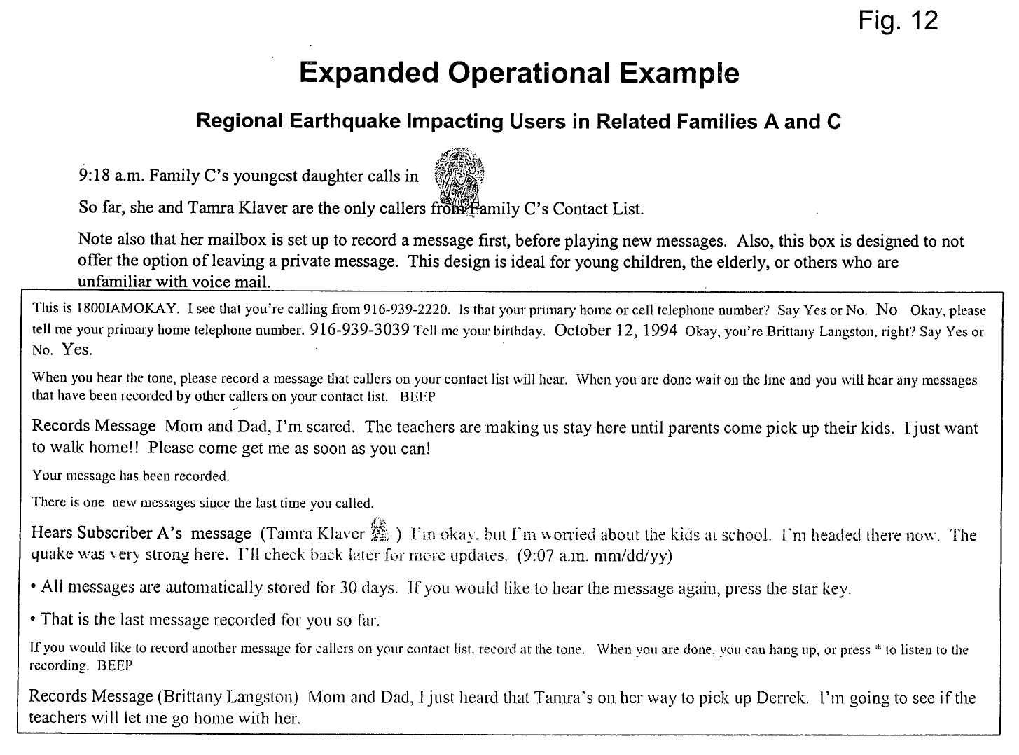

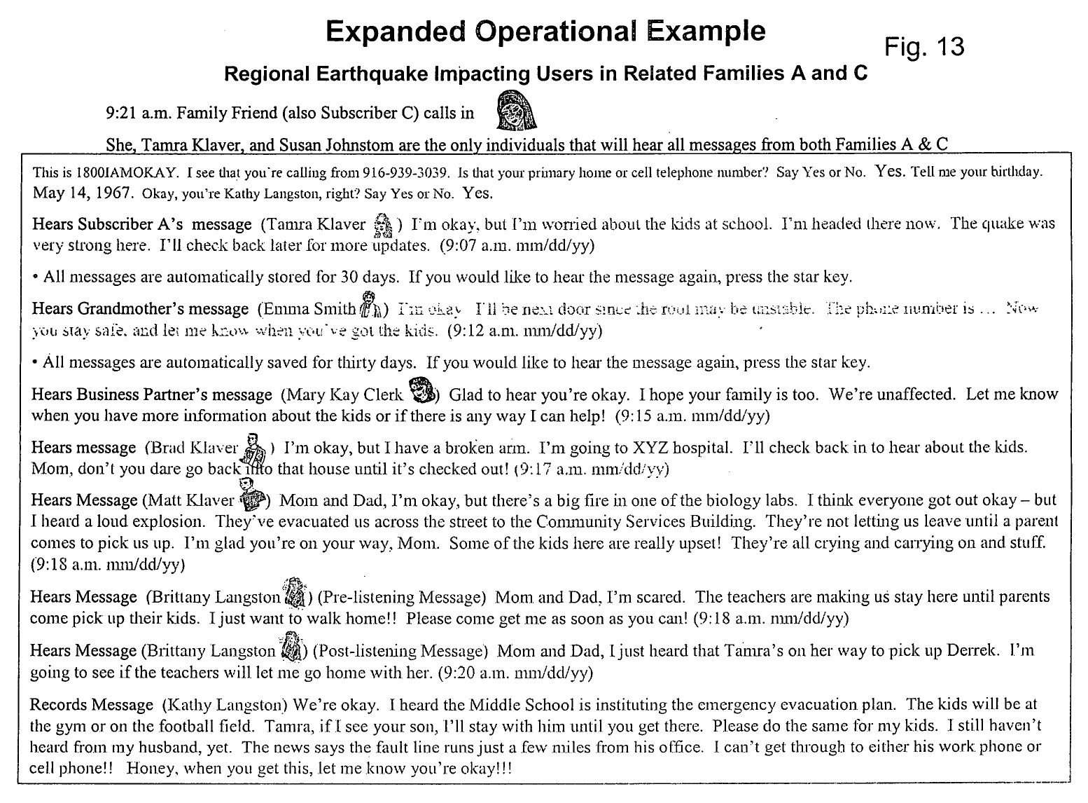

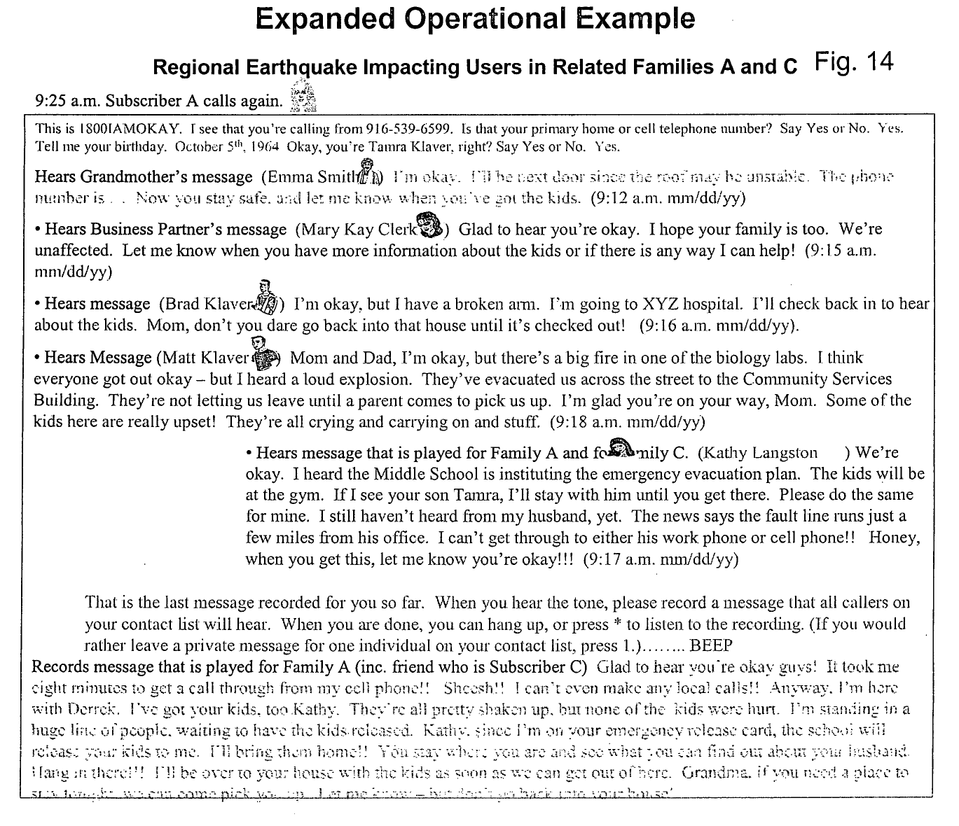

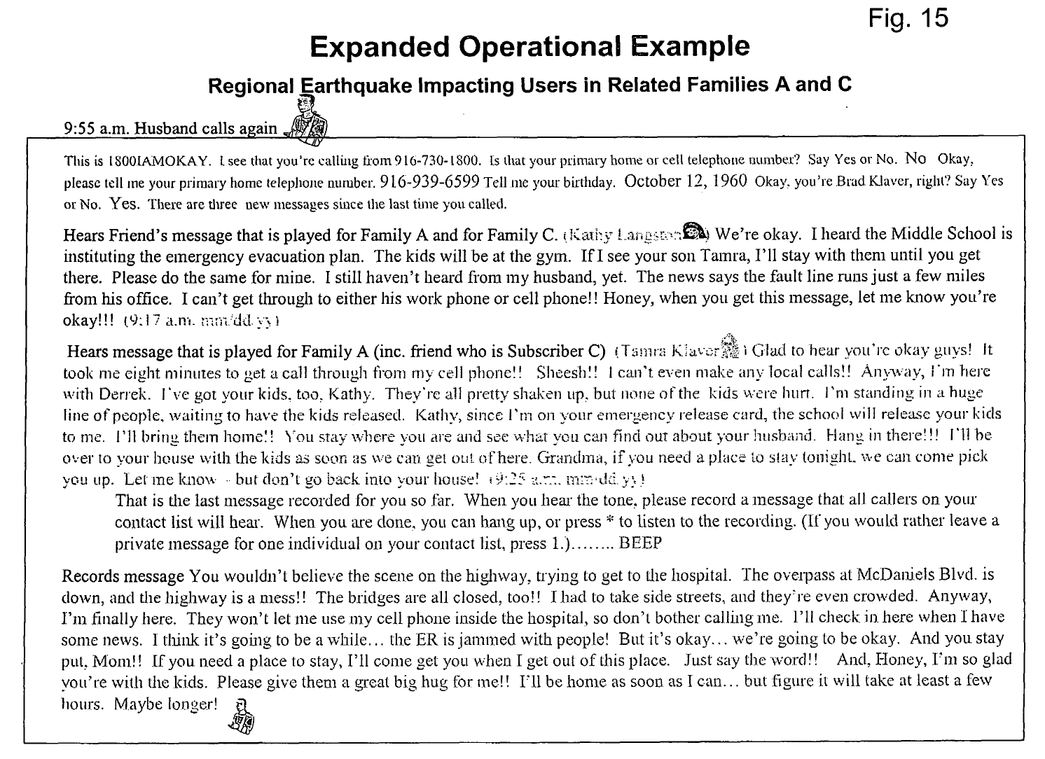

FIG. 6 provides an abbreviated example of how the system of FIG. 1 would work in a specific crisis, such as an earthquake. FIGS. 7-15 provide an expanded example of the method described in FIG. 6. Subscribers A1 and C1 have, when setting up their contact lists, indicated that they wish to provide each other access to all messages left in the each of the personal boxes associated with families A and C. Subscriber C is a friend of subscriber A's family. In addition, subscriber A has set up personal boxes for the subscriber's grandmother, business partner, husband, and accountant.

Initially, subscriber A calls in and leaves a message. Then, in succession, grandmother, business partner, husband, son, Subscriber C's young daughter, and subscriber C call in, listen to previous messages, and leave their own messages. Subscriber A then calls in again, hears messages and records a new message, after which husband calls in, hears new messages and records an additional new message.

It is apparent from the example of FIGS. 6 and 7-15 that the invention can provide communication capabilities that are especially useful in a crisis, and that go way beyond the capabilities of a conventional voice mail system, including the capability of distributing messages among related boxes, and of designating subscribers other than the primary subscriber for a family to access the messages.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention.

For example, the system may be set up to use some ports for outbound calls to verify phone numbers in case the numbers have not been updated (unless the system is handling a predetermined threshold of inbound calls such as in a crisis, in which those ports would revert to inbound call handling). The system could send email messages to subscribers with email or make outcalls once per year to each subscriber without email access in the database, asking the person to verify that the phone number and other information is still correct for that subscriber. Where there is any uncertainty that the subscriber has been reached, the system could generate an email message for the primary subscriber that the information needs to be verified and updated through the customer service center, if necessary.

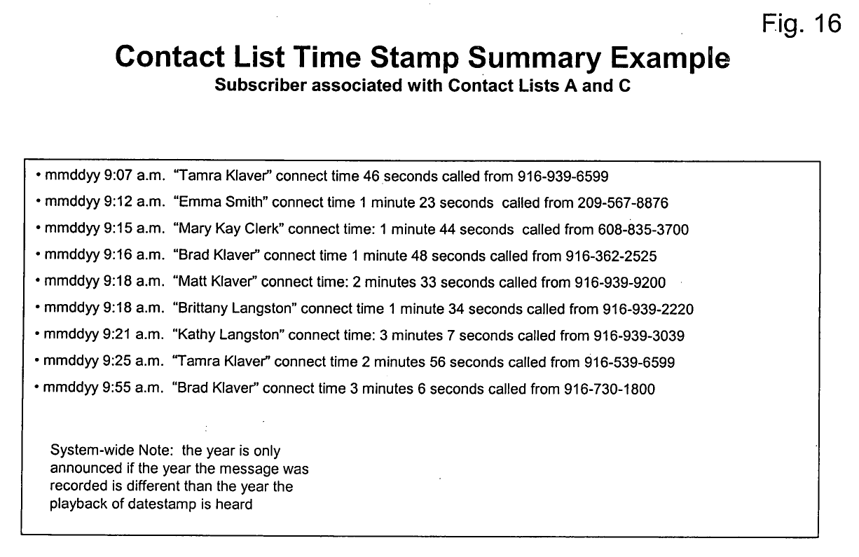

In addition, there may also be an option for any personal box subscriber to press a series of keys (such as ***, for example) which would cause the system to read a time/date-stamped listing of all calls received by phone numbers associated with the personal box's contact list (such as the listing illustrated in FIG. 16)

Consequently, it is intended that the invention not be limited by the above description or accompanying drawings, but that it be defined solely in accordance with the appended claims.

What is claimed is:

1. A crisis communication system including at least one crisis communication point (CCP) having a system box connected to multiple telephone lines, comprising:
subscriber personal boxes, each associated with a subscriber, and each accessible upon entry of one of a plurality of phone numbers associated with a respective personal box, and potentially associated with other personal boxes; and
additional personal boxes, each associated with a particular plurality of other personal boxes, each personal box being accessible upon entry of a unique combination of numbers determined as a phone number augmented by a personal box identifier,
wherein respective said personal boxes are associated with one or more contact lists such that a message recorded in one of said personal boxes associated with said one or more contact lists is automatically distributed to at least one other of the personal boxes associated with one or more of said contact lists.

2. A crisis communication system as claimed in claim 1, wherein a person accessing said at least one other of the personal boxes may respond to the message by recording a reply message in said at least one other of the personal boxes, said reply message being distributed at least to said one of said personal boxes.

3. A crisis communication system as claimed in claim 2, wherein said message and reply message are automatically distributed to all of said personal boxes associated with one or more contact lists.

4. A crisis communication system as claimed in claim 2, wherein said plurality of numbers include one or more telephone numbers of selected callers.

5. A crisis communication system as claimed in claim 4, wherein multiple telephone numbers are associated with a single said contact list, a single said personal box, or a single said contact list and a single said personal box.

6. A crisis communication system as claimed in claim 4, wherein when a call is received by said system box, a caller is asked if the phone number appearing on a Caller ID is the subscriber's primary home or cell phone number, and if not, is prompted to enter the caller's home or mobile telephone number, the telephone number is compared with telephone numbers in a system database and, if a match is found, the telephone call is associated with one or more personal boxes corresponding to the caller's telephone number.

7. A crisis communication system as claimed in claim 1, wherein said personal box identifier is a birth date or similar identifier of an individual assigned to said personal box.

8. A crisis communication system as claimed in claim 7, wherein access to said personal boxes also requires input of a password common to all said personal boxes associated with a respective family box.

9. A crisis communication system as claimed in claim 8, wherein a caller is prompted by the system box to input a personal identifier and password, wherein the personal identifier and password input by the caller are compared with personal identifiers and passwords in a database associated with the caller's telephone number, and wherein if the input password matches a personal identifier and password in the database, the telephone call is routed to a personal box associated with the personal identifier.

10. A crisis communication system as claimed in claim 1, wherein said personal boxes are further linked to personal boxes in a different group of personal boxes, whereby messages distributed to personal boxes in one family are automatically distributed to personal boxes in a second family.

11. A crisis communication system as claimed in claim 1, further comprising additional redundant CCPs with networked and mirrored databases and message stores in geographically dispersed areas for enabling messages to be accessed even if one CCP is disabled during a crisis or if all of the ports at a primary CCP are busy.

12. A crisis communication system as claimed in claim 1, further comprising next-of-kin notification cards containing information enabling officials or medical personnel to leave messages in personal boxes of next-of-kin in the event that a subscriber has died or is unable to communicate.

13. A method of facilitating communications during a crisis, comprising the steps of:
operating a crisis communication point (CCP) including a system box;
operating a plurality of subscriber personal boxes, each associated with a single subscriber, and each accessible upon entry of one of a plurality of telephone numbers associated with other personal boxes;
operating a plurality of additional personal boxes, each additional personal box associated with a particular plurality of other said personal boxes on a contact list, each personal box being accessible upon entry of a unique combination of numbers determined as a telephone number augmented by a personal box identifier; and
automatically distributing a message recorded in one of said plurality of personal boxes associated with one or more contact lists.

14. A method of facilitating communications during a crisis as claimed in claim 13, further comprising the step of enabling a person accessing a personal box to replay or record a message.

15. A method of facilitating communications during a crisis as claimed in claim 13, wherein said message is automatically distributed to all of said personal boxes associated with one or more contact lists.

16. A method of facilitating communications during a crisis as claimed in claim 13, wherein said plurality of telephone numbers include one or more telephone numbers of selected callers.

17. A method of facilitating communications during a crisis as claimed in claim 13, wherein multiple telephone numbers are associated with a single said contact list, personal box, or contact list and personal box.

18. A method of facilitating communications during a crisis as claimed in claim 13, further comprising the steps of, when a call is received by said system box, announcing the telephone number showing on a caller's Caller ID, asking if the number announced is one of the subscriber's primary phone numbers, if not, prompting a caller to enter the caller's home or mobile telephone number, comparing the telephone number with telephone numbers in a system database and, if a match is found, associating the telephone call with one or more personal boxes corresponding to the caller's the telephone number.

19. A method of facilitating communications during a crisis as claimed in claim 13, wherein said personal box identifier is a birth date or similar identifier of an individual assigned to said personal box.

20. A method of facilitating communications during a crisis as claimed in claim 19, wherein access to said personal boxes also requires input of a password common to all said personal boxes associated with a respective contact list or group of personal boxes.

21. A method of facilitating communications during a crisis as claimed in claim 20, further comprising the steps of prompting a caller to input a personal identifier and optional password, comparing the personal identifier and password input by the caller with personal identifiers and passwords in a database associated with the telephone number corresponding to said one or more personal boxes and, if the input password matches a personal identifier and password in the database, routing the telephone call to a personal box associated with the personal identifier.

22. A method of facilitating communications during a crisis as claimed in claim 13, wherein said personal boxes are further linked to personal boxes in a different group of personal boxes, whereby messages distributed to personal boxes in one family are automatically distributed to one or more personal boxes in a second family.

23. A method of facilitating communications during a crisis as claimed in claim 13, further comprising the step of providing additional redundant CCPs with networked and mirrored databases and message stores in geographically dispersed areas for enabling messages to be accessed even if one CCP is disabled during a crisis, or if all ports of a primary CCP are busy.

24. A method of facilitating communications during a crisis as claimed in claim 13, further comprising the step of providing next-of-kin notification cards containing information enabling officials or medical personnel to leave messages in personal boxes of next-of-kin in the event that a subscriber has died or is unable to communicate.

25. A telephone message access system, comprising:
subscriber personal boxes, each associated with a subscriber and a plurality of phone numbers, and each accessible upon entry of any one of the plurality of phone numbers associated with a respective personal box.

26. A telephone message access system as claimed in claim 25, wherein the plurality of phone numbers include a home phone number and a cell phone number.

27. A telephone message access system as claimed in claim 25, wherein respective said personal boxes are associated with one or more contact lists such that a message recorded in one of said personal boxes associated with said one or more contact lists is automatically distributed to at least one other of the personal boxes associated with one or more of said contact lists.

28. A telephone message access system, comprising:
a plurality of personal voice mail boxes associated with at least one common phone number, each personal voice mail box being accessible upon entry of a unique combination of numbers including said common phone number augmented by a personal box identifier.

29. A telephone message access system as claimed in claim 28, wherein respective said personal boxes are associated with one or more contact lists such that a message recorded in one of said personal boxes associated with said one or more contact lists is automatically distributed to at least one other of the personal boxes associated with one or more of said contact lists.
